(19) United States
(12) Patent Application Publication
(10) Pub. No.: US 2014/0093145 A1
(43) Pub. Date: Apr. 3, 2014

(54) Algorithms For Hardware-Oriented Biometric Matching

(71) Applicant: Dannie Gerrit Feekes, El Dorado Hills, CA (US)

(72) Inventor: Dannie Gerrit Feekes, El Dorado Hills, CA (US)

(21) Appl. No.: 14/044,864

(22) Filed: Oct. 2, 2013

Related U.S. Application Data
(60) Provisional application No. 61/709,131, filed on Oct. 2, 2012.
(60) Provisional application No. 61/709,267, filed on Oct. 3, 2012.
(60) Provisional application No. 61/709,358, filed on Oct. 4, 2012.

(51) Int. Cl. G06K 9/00

(52) U.S. Cl. CPC G06K 9/00006
USPC 382/124

(57) ABSTRACT

The present disclosure provides an integrated circuit configured to perform a method of filtering biometric data as a stream of fingerprint image data is received. The method implemented by the integrated circuit includes receiving an incoming stream of biometric data from a biometric sensor; counting the number of bytes that exceed a programmable threshold over a given area as the data is received from the biometric sensor; and using the count for the given area to dynamically adjust the filter logic that is applied within the given area.

### CROSS-REFERENCE TO RELATED APPLICATIONS

This application claims the benefit of the following provisional patent applications which are herein incorporated by reference: (1). Provisional Patent Application No. 61/709,131 filed on Oct. 2, 2012; Provisional Patent Application No. 61/709,267 filed on Oct. 3, 2012; and Provisional Patent Application No. 61/709,358 filed on Oct. 4, 2012.

### BACKGROUND

Biometric identification and verification has increasingly been put forward as a solution to solving the increasing growth of various forms of identity theft and fraud. In this regard, biometrics is the use of biological or behavioral characteristics such as fingerprints, retina, voice, signature, keystroke patterns etc. to uniquely identify a person. Among the different forms of biometrics, fingerprint-based identification is the most reliable and popular method and is currently applied in certain types of applications. The patterns formed by the lines or ridges that make-up a fingerprint are unique and immutable for each individual and can be reliably used for identification purposes.

In certain scenarios, biometric verification systems have been successfully adopted and used to provide improved security and prevent fraudulent activities. Fingerprint verification is most widely applied today in instances when a dedicated power source is available to power a device that processes a scan of a finger for comparison to a stored fingerprint image and/or template. For example, fingerprint verification systems have been widely adopted by US-based law enforcement for security at border crossings to prevent and/or track the movement of potentially dangerous individuals. In contrast, fingerprint verification has not been widely implemented in embedded applications where a dedicated power source is not available. While there is a substantial incentive to perform biometric verification in embedded applications, the demand in this context has gone largely unfulfilled.

In embedded applications, small and/or inexpensive fingerprint sensors are typically used. As a result, less information is typically available to perform the biometric match in this context. Unfortunately, systems available today that performs a biometric match are highly susceptible to imperfect image quality produced by the fingerprint sensors that are suitable for embedded applications. Moreover, a limited amount of power is available to power a device that performs a biometric match in these scenarios. In this regard, the biometric matching systems for embedded applications which currently exist have a number of drawbacks relating to reliability, speed, form factor, cost, and flexibility.

### SUMMARY

This summary is provided to introduce a selection of concepts in a simplified form that are further described below in the Description. This summary is not intended to identify key features of the claimed subject matter, nor is it intended to be used as an aid in determining the scope of the claimed subject matter.

The present disclosure provides an integrated circuit configured to perform a method of filtering biometric data as a stream of fingerprint image data is received. The method implemented by the integrated circuit includes receiving an incoming stream of biometric data from a biometric sensor; counting the number of bytes that exceed a programmable threshold over a given area as the data is received from the biometric sensor; and using the count for the given area to dynamically adjust the filter logic that is applied within the given area.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is a block diagram depicting an exemplary environment where described embodiments of the disclosed subject matter can be implemented;

FIG. 2 is a pictorial depiction suitable for illustrating various aspects of the present disclosure;

FIG. 3 is a block diagram suitable for describing various embodiments of the present disclosure;

FIG. 4 is a pictorial depiction suitable for illustrating various aspects of the present disclosure;

FIG. 5 is a block diagram suitable for describing various embodiments of the present disclosure;

FIG. 6 is a block diagram suitable for describing various embodiments of the present disclosure;

FIG. 7 is a block diagram suitable for describing various embodiments of the present disclosure;

FIG. 8 is a block diagram suitable for describing various embodiments of the present disclosure;

FIG. 9 is a block diagram suitable for describing various embodiments of the present disclosure;

FIG. 10 is a block diagram suitable for describing various embodiments of the present disclosure;

FIG. 11 is a block diagram suitable for describing various embodiments of the present disclosure;

FIG. 12 is a block diagram suitable for describing various embodiments of the present disclosure;

FIG. 13 is a block diagram suitable for describing various embodiments of the present disclosure;

FIG. 14 is a block diagram suitable for describing various embodiments of the present disclosure;

FIG. 15 is a block diagram suitable for describing various embodiments of the present disclosure; and

FIG. 16 is a block diagram suitable for describing various embodiments of the present disclosure.

### DESCRIPTION

The description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. In this regard, the following description first provides a general description of environments in which the disclosed subject matter may be implemented and then additional aspects of the disclosure are described. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

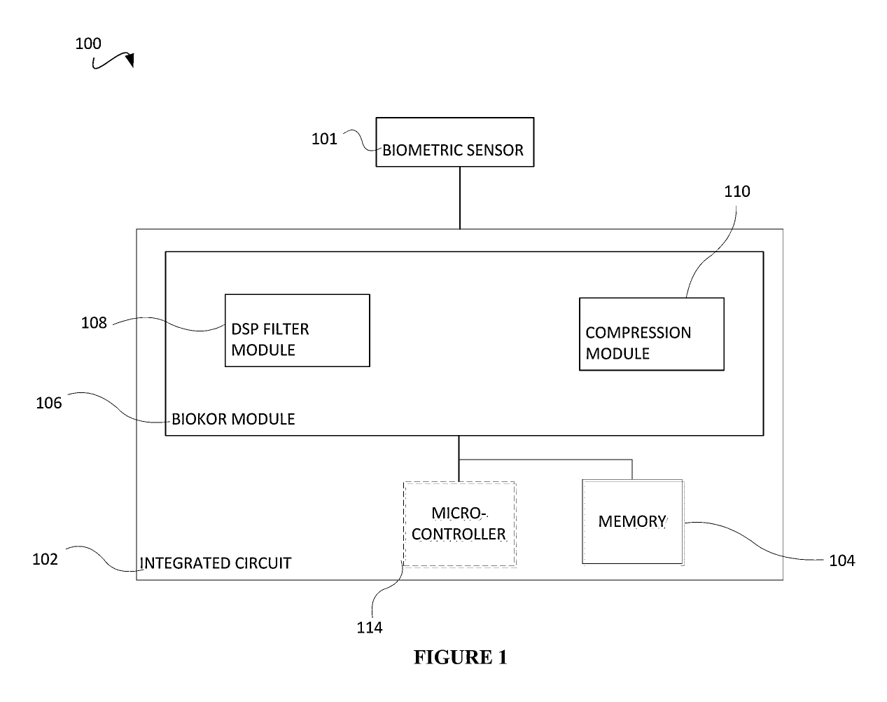

Now with reference to FIG. 1, an exemplary system 100 in accordance with the present disclosure will be described. To support a biometric authentication, the system 100 includes at least one biometric sensor 101 capable of capturing a biometric attribute of a user. For example, the biometric sensor 101 may be a fingerprint sensor (either an area or swipe sensor) capable of capturing a representation of a user's fingerprint and provide the captured data to the integrated circuit 102 in a data stream. In instances when fingerprint data is being captured, the biometric sensor 101 may be an area sensor in which all aspects of the easiest fingerprint are captured simultaneously. Alternatively, the biometric sensor 101 may be a swipe sensor in which the fingertip is moved over the sensor so that the fingertip skin is scanned sequentially, row by row. The swipe fingerprint sensors are particularly suited for portable devices because of their small size and low cost. Nonetheless, the processing performed by the present disclosure is agnostic to sensor type. Moreover, the biometric sensor 101 may also be or include anodes for capturing a heartbeat waveform, an optical sensor for capturing iris data, or any other biometric sensor capable of capturing a biometric attribute of a user. While the descriptions provided herein are made primarily with reference to identifying fingerprints, other biometric information and/or sources may also be utilized (e.g. iris, heartbeat, hand print, voice, vein, etc.) and the examples provided herein should be construed as exemplary.

As further illustrated in FIG. 1, the system 100 further includes an integrated circuit 102 which may be any number of different types of circuits such as an ASIC (Application Specific Integrated Circuit), an FPGA (Field Programmable Gate Array), a System-on-Chip (SOC), a general purpose processor, a special purpose processor, a digital signal processor (DSP), a controller (such as a memory controller), a microcontroller, any other type of integrated circuit (IC), and/or a state machine. In the exemplary embodiment depicted in FIG. 1, the integrated circuit 102 includes a memory 104 which may be any type of memory capable of storing data and may include volatile memory and/or non-volatile memory. Volatile memories may include, but are not limited to static random access memory (SRAM), pseudo-static random access memory (PSRAM), and dynamic random access memory (DRAM). DRAM types may include single data rate (SDR) DRAM, double data rate (DDR) DRAM, low power (LP) DDR DRAM, and any other types of DRAM. Nonvolatile memory types may include magnetic RAM (MRAM), flash memory, resistive RAM (RRAM), ferroelectric RAM (FeRAM), phase-change RAM (PRAM), electrically erasable programmable read-only memory (EEPROM), laser programmable fuses, electrically programmable fuses (e-fuses), and any other types of nonvolatile memory. Embodiments of the present disclosure may generally be used with any type of memory. Moreover, the memory 104 may be either internal or external to the chip package, without departing from the scope of the claimed subject matter. Depending on the specific application, the integrated circuit 102 may and typically will include additional functional blocks than depicted in FIG. 1.

As mentioned previously, biometric data captured using the biometric sensor 101 is provided to the integrated circuit 102 where the data is processed. In accordance with one embodiment, the BioKor module 106 implements hardware-based logic to filter the biometric data in real-time (as the scan is performed) without having to substantially buffer the image data in memory 104. One skilled in the art will recognize that existing solutions typically rely on devices and methods that perform post processing after a biometric image is stored in memory. More specifically, data captured by a biometric sensor is read by a microcontroller and then written to either an internal or external memory. Once in memory, firmware/software is typically responsible for a number of post processing routines (e.g. block averaging, Gaussian mean distribution, and the like) that improve the sensor signal to noise ratio and quality of the biometric data. However, the amount of data captured by a biometric sensor is large and the software-based post processing routines typically require an extensive amount of computing resources (microcontroller, power, memory, etc.). As a result, these solutions are not cost effective or well suited for certain applications such as embedded devices. In contrast, the BioKor module 106 provided by the present disclosure is a circuit that processes an incoming stream of biometric data. In this regard, the BioKor module 106 includes the DSP filter module 108 and the compression module 110. The logic implemented in the individual functional blocks 108-110 depicted in FIG. 1 will each be described in further detail below.

As is evident by the description provided herein and in accordance with one embodiment, the functionality of the modules 106-110 may be implemented in hardware-based logic that may be integrated or embedded into virtually any type of integrated circuit, multiple circuits, and/or other similar type of component(s). In one embodiment, the integrated circuit 102 is programmable such that certain hardware routines and functionality described herein provide hardware acceleration to a software-based matching algorithm such that certain functions can execute faster and utilize less resources than is possible for software/firmware being executed by the micro-controller 114. In yet another embodiment, a software-based biometric solution is implemented in firmware executed by the micro-controller 114. In this instance, software algorithms or routines that filter and authenticate the incoming biometric image are loaded into volatile memory by an operating system (not illustrated) and executed by the micro-controller 114. In instances when the biometric matching logic does not rely on software/firmware, the microcontroller 114 is an optional component and may not be included in the integrated circuit 102 as visually indicated in FIG. 1.

As mentioned above, the integrated circuit 102 includes the DSP filter module 108 that filters an incoming stream of biometric data in a way that reduces or eliminates certain sensor anomalies. In one embodiment, this data is filtered in real-time as the data is received from the biometric sensor 101. As will be clear in the description that follows, the disclosed architecture and functionality of the DSP filter module 108 implements logic that improves the biometric sensor signal to noise ratio such that accurate biometric authentication can be performed without the additional cost and power of large memories and micro-controller based post processing.

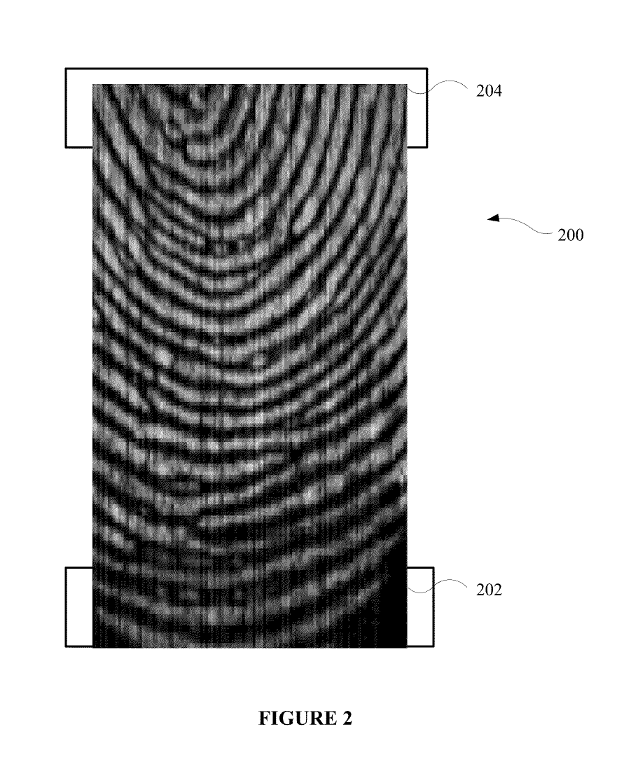

Now with reference to FIG. 2, a number of image anomalies that have been identified using existing biometric sensors will be described. A widespread problem in most biometric sensors is that there is a large variation in the quality of captured data across the raw fingerprint image 200. In capacitive coupled swipe fingerprint sensors, for example, the pressure exerted on the sensor may not be constant across the horizontal or vertical axis resulting in variations in quality across an image. In particular, when a finger is initially placed on a fingerprint sensor, the entire skin surface may not be in contact with the sensor surface thereby resulting in the area 202 of the raw fingerprint image 200 having a minimal amount of contrast variation between the fingerprint ridge lines and valleys. By contrast, improved contact between the skin surface and the sensor may result in the area 204 of the raw fingerprint image 200 having a substantial amount of contrast between the fingerprint ridge lines and valleys. However, the end result is a raw fingerprint image 200 where the contrast variation can vary substantially across the image and even on the same horizontal scan line or column. Moreover, the fingerprint image 200 illustrates a number of “striping” sensor anomalies or vertical lines that do not represent the user's actual fingerprint that are a product of inexpensive design/fabrication of the capacitive coupling sensors. These anomalies depicted in FIG. 2 become problematic for matching algorithms and have required sampling and processing of images over large areas to improve the image quality. However, to achieve an acceptable authentication accuracy, the end result has previously been a biometric authentication architecture that is expensive and consumes an unacceptable amount of power.

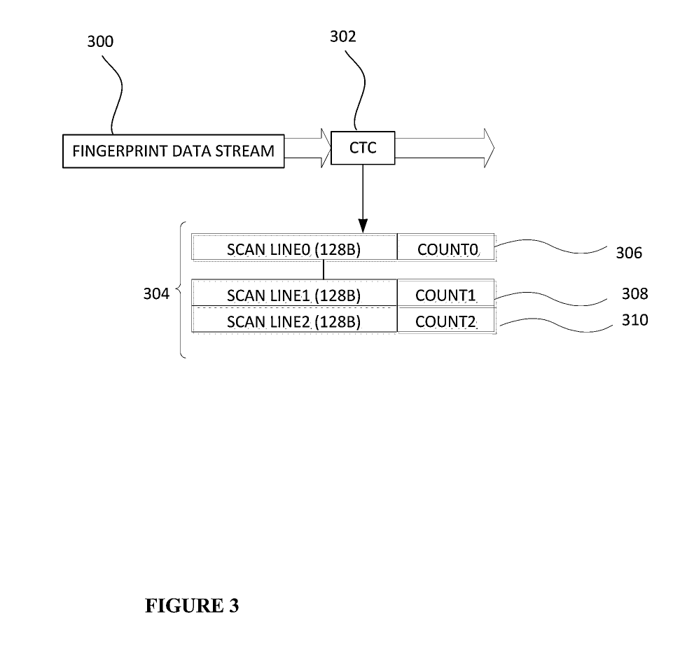

Now with reference to FIG. 3, a DSP filter algorithm configured to improve the quality of a fingerprint image as the data is received from a sensor (capacitive sensor, optical sensor, etc.) will be described. The algorithm is one which is agnostic of the sensor type and utilizes characteristics unique to a fingerprint image to predictively improve the data quality in the absence of data due to sensor errors and anomalies. As illustrated in FIG. 3, incoming fingerprint data stream 300 is processed by a series of contrast threshold counters (CTC) 302 that are configured to count the number of bytes that exceed a programmable threshold. In the embodiment depicted in FIG. 3, rows of data in the fingerprint data stream 300 are held in the FPS FIFO 304. One first unique aspect of the architecture of the present disclosure is an ability to provide a DSP filter algorithm with as few as three scan lines 306, 308, and 310 of fingerprint image data at a given time. This is important to a hardware-based pattern matching biometric architecture due to the fact that very little memory is used and the image can be processed in real-time as it is being read from the sensor. For example, with a fingerprint image width of 128 pixels, only 384 bytes of internal storage may be used to process the stream of incoming fingerprint image data. In one embodiment, this aspect of the memory architecture is implemented in hardware as a three entry by 128 Byte FIFO 304 in which data is read from its memory array in the same order that the data is written and where there is one entry in the FPS FIFO per horizontal scan line. However, as one skilled in the art will recognize, aspects of the present disclosure may be implemented in other ways without departing from the scope of the claimed subject matter.

As illustrated in FIG. 3, a series of CTCs 302 are provided which count the number of bytes that exceed a programmable threshold for each scan line maintained of the FPS FIFO 304. In this regard, a series of per column CTCs can also be added to provide greater contrast variation data. By counting the number of bytes that exceed a given threshold, aspects of the present disclosure are able to dynamically adjust the filter logic for contrast variation across the fingerprint image in both the horizontal and vertical directions.

For the purposes of pattern matching, a fingerprint image can be compressed down to a single bit for every data point. In the example depicted in FIG. 2 and described herein, a biometric sensor may provide an image in 8-bit grey scale. In one embodiment, the DSP filter algorithm provided by the present disclosure processes each byte in the fingerprint data stream 300 and converts it to either a high or low contrast pixel. In the exemplary embodiment described with reference to FIGURE, a 3×3 Byte matrix is used in determine whether the central byte in the matrix is a high or low contrast pixel. In Table 1 below, data patterns based on a high/low the contrast threshold values (CTV) derived from the CTC 302 output centered on a byte in scan_line1 308 of the FPS FIFO 304 is provided.

TABLE 1

| | | | | | |
|---|---|---|---|---|---|
| >CTV | >CTV | >CTV | >CTV | >CTV | |
| >CTV | 1 | >CTV | >CTV | 1 | |
| >CTV | >CTV | >CTV | >CTV | >CTV | |
| | >CTV | >CTV | >CTV | >CTV | >CTV |
| | 1 | >CTV | >CTV | 1 | |
| | >CTV | >CTV | >CTV | | |
| >CTV | >CTV | >CTV | | | >CTV |
| | 1 | >CTV | | 1 | >CTV |
| | | >CTV | >CTV | >CTV | >CTV |
| >CTV | | | >CTV | >CTV | >CTV |
| >CTV | 1 | | >CTV | 1 | >CTV |
| >CTV | >CTV | >CTV | | | |
| | | | | >CTV | |
| >CTV | 1 | >CTV | >CTV | 1 | >CTV |
| >CTV | >CTV | >CTV | | >CTV | |
| >CTV | | | | >CTV | >CTV |
| >CTV | 1 | >CTV | >CTV | 1 | >CTV |
| | >CTV | >CTV | >CTV | | |
| >CTV | >CTV | | | | >CTV |
| >CTV | 1 | >CTV | >CTV | 1 | |
| | | >CTV | >CTV | >CTV | |

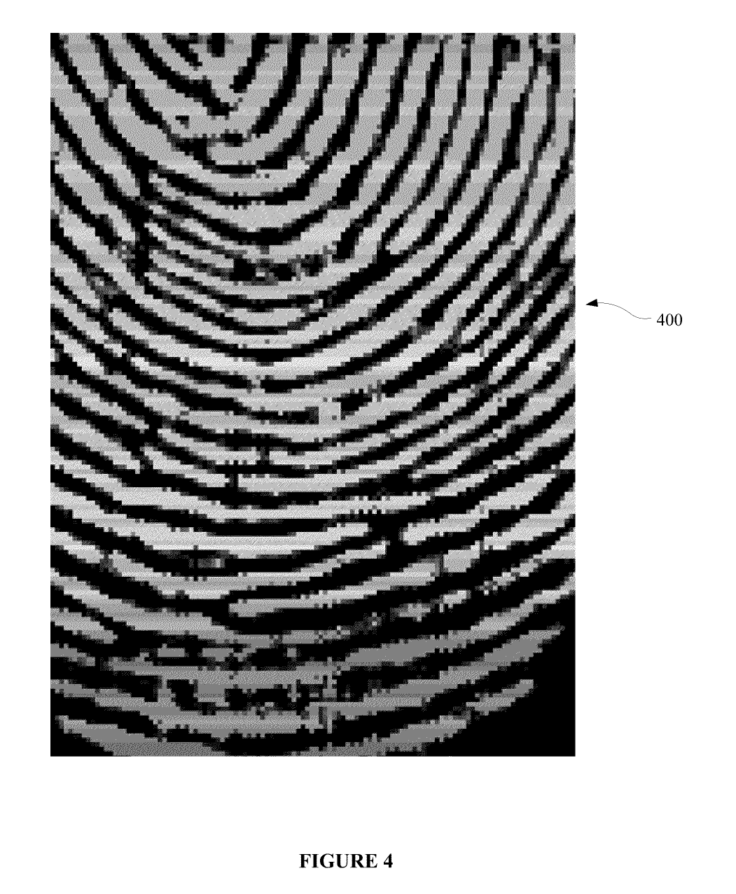

In one embodiment, the CTV calculation may be sensor dependent. In an optical sensor, the CTV typically has a linear relationship between the horizontal/vertical CTC 302 values such that CTV=A((CTCv+CTCh)/2)+B. In this regard, the A and B values are derived through characterization of the specific sensor used. For other sensor technologies (e.g. active capacitive coupling), the contrast may vary as a function of Vt on the capacitive gate. In this regard, other sensors may use a different CTV on a per column basis. Moreover, CTV may be calculated uniquely based on the CTC value and the vertical position of the pixel in the image (i.e. scan_line1 308). Essentially, the positional calculation of CTV may provide a uniform and dynamic contrast variation correction across the finger print image. As a result, the DSP filter algorithm provided by the present disclosure is able to avoid large portions or the entire image being stored in memory and post processed to improve image quality. The filtering can be done on the fly and provides uniform contrast across the image yielding reduced complexity, gates, power and cost in the matching logic. The fingerprint image depicted in FIG. 4, was generated using the DSP filter algorithm described herein using less than 5K gates.

As mentioned above, the integrated circuit 102 (FIG. 1) includes the compression module 110 configured to compress certain data especially image data on a horizontal scan line. An important element to real time, hardware implemented, data pattern matching for biometric recognition is to compress the fingerprint data. By doing this, it is possible to implement a recognition design, in hardware, that does not need to buffer image data or perform any post processing. Instead, only a small window of compressed scan lines is potentially used to facilitate accurate recognition for the pattern matching hardware. A further advantage is that the storage footprint of the fingerprint template used by the recognition hardware is in a compressed state thereby reducing the necessary footprint of the integrated circuit 102 (FIG. 1). The hardware logic described below may receive a portion or full scan line of data representing the contours of a fingerprint along the x-axis. In some implementations of the compression module 110 there are two duplicate sets of the logic described below. The first set may detect the high contrast data while the second set detects the low contrast data. Moreover, a programmable/configurable high and low contrast register may be provided which delineates the peak and valley qualification.

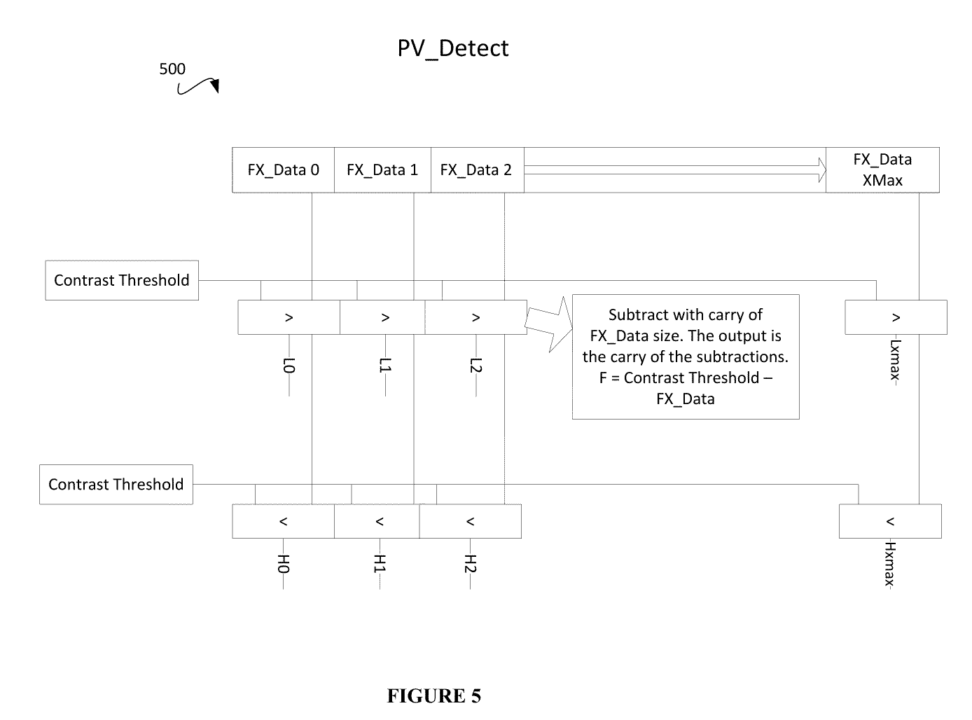

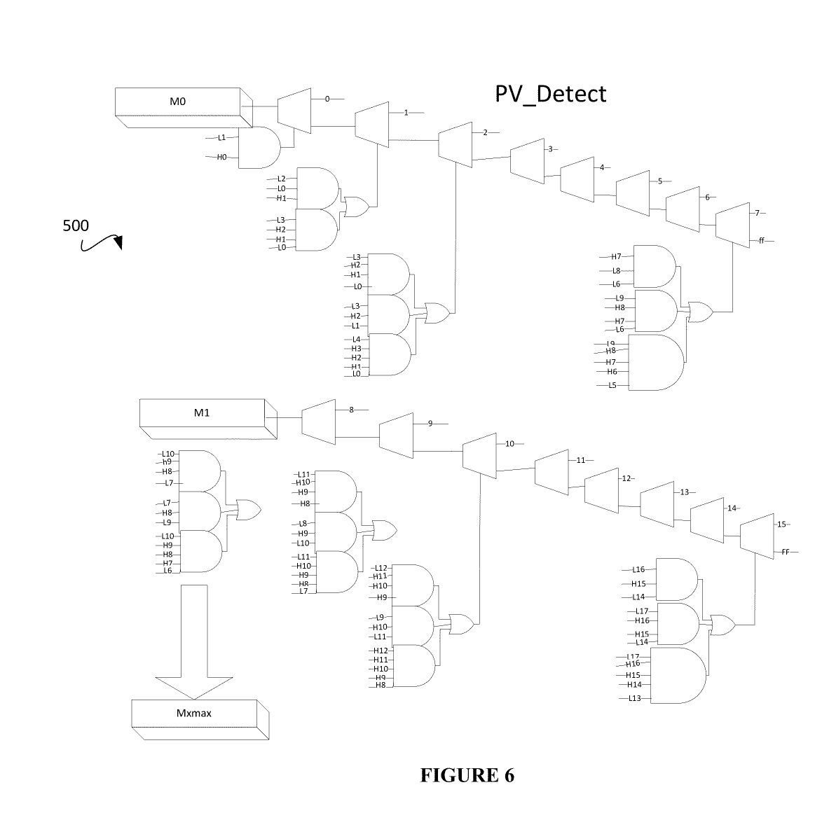

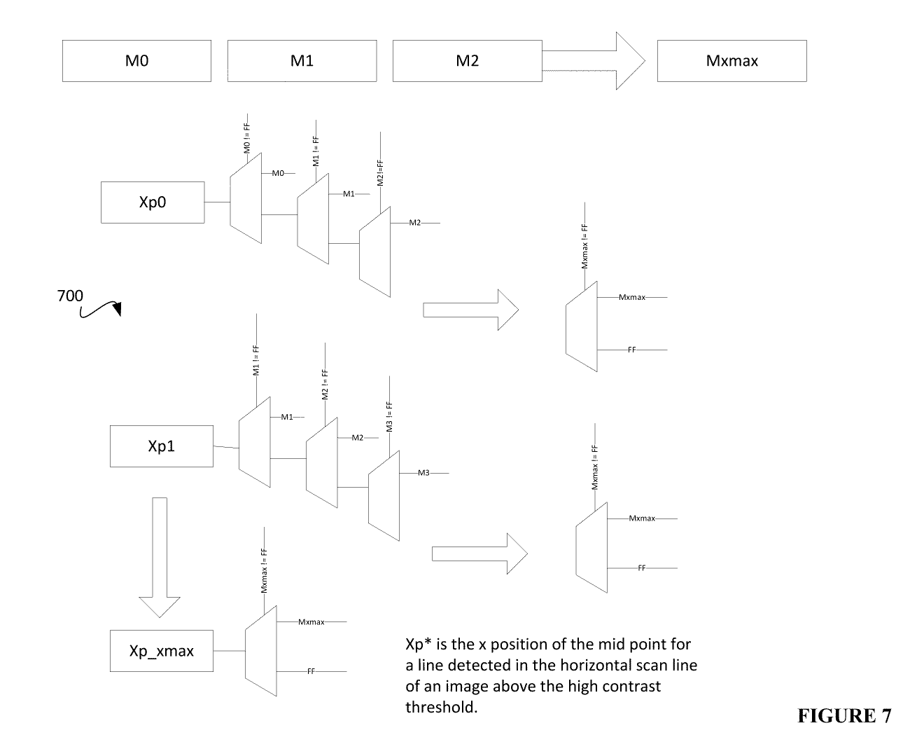

Now with reference to FIGS. 5-6, PV_Detect logic 500 provided by the compression module 110 that has the ability to recognize the x-axis start and end of a contour line (which may represent a fingerprint ridgeline) will be described. For each x-axis contour start and end point, the PV_Detect logic 500 identifies the midpoint and stores the x-axis location of this midpoint in a “peak group” register file. In this regard, FIG. 6 visually depicts that digital logic for generating the peak group register file which is comprised of entries “M0, M1, . . . Mxmax”. Given that high/low contrast data is processed in parallel, the logic utilized to detect and sequentially align may be multi-stage for scan lines having over 32-bits of data. The PV_Detect logic 500 depicted in FIGS. 5-6 is the first stage where the high and low contrast points are detected. The second stage takes the peak groups (i.e. “M0, M1, . . . Mxmax”) and aligns them sequentially according to their x-axis coordinate locations in accordance with the digital logic diagram 700 depicted in FIG. 7. The α register file for each high contrast point may be used to generate pointers which bound the compare range of the next point in the high contrast line. The next high contrast point in the line traversing the y-axis may be selected from one plus and minus the delta transition (indicated by α[i]=!α[i]) as described in further detail below.

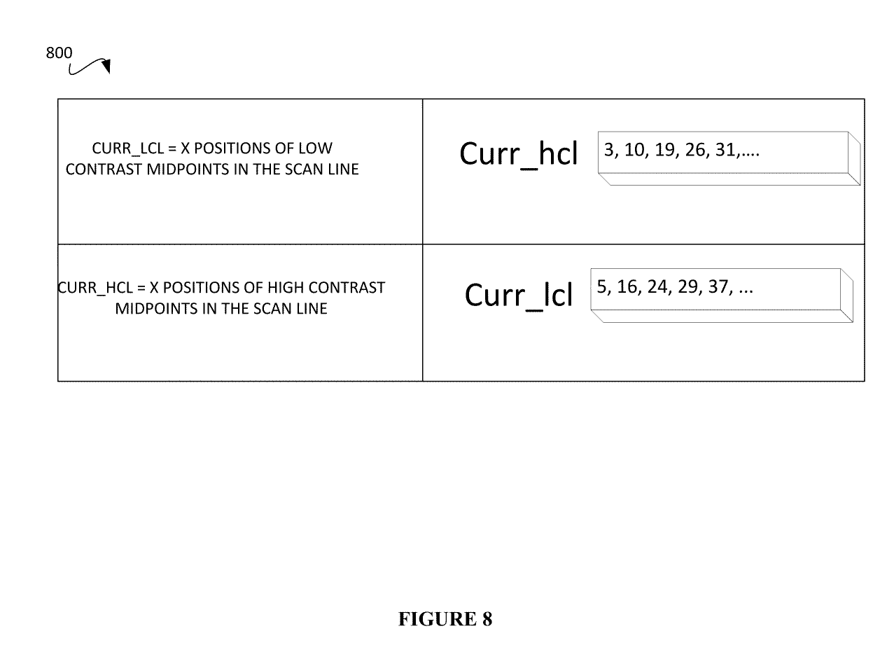

The scan line compression logic of the present disclosure may output two register files consisting of MAX_LINE_LEN entries of ScanX type data. One register file may contain the x-position of the high contrast mid points. The other register file may contain all the x-positions in the scan line for the low contrast midpoints as visually depicted in the table 800 illustrated in FIG. 8.

The logic shown in Table 2 below may be used to find the x-position of the closest low contrast point for each high contrast point. This may be completed for the purpose of framing the bounds of the line forming the high contrast line. In one embodiment, all low contrast lines that are to the left (less than) the high contrast point and all points to the right (greater than) are identified. This can be used by the absolute value logic where the x-position delta between the closest low contrast points for each high contrast point

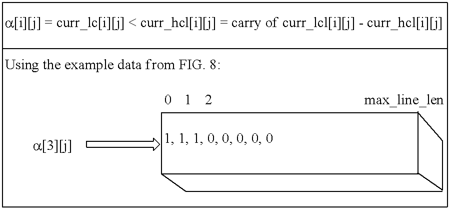

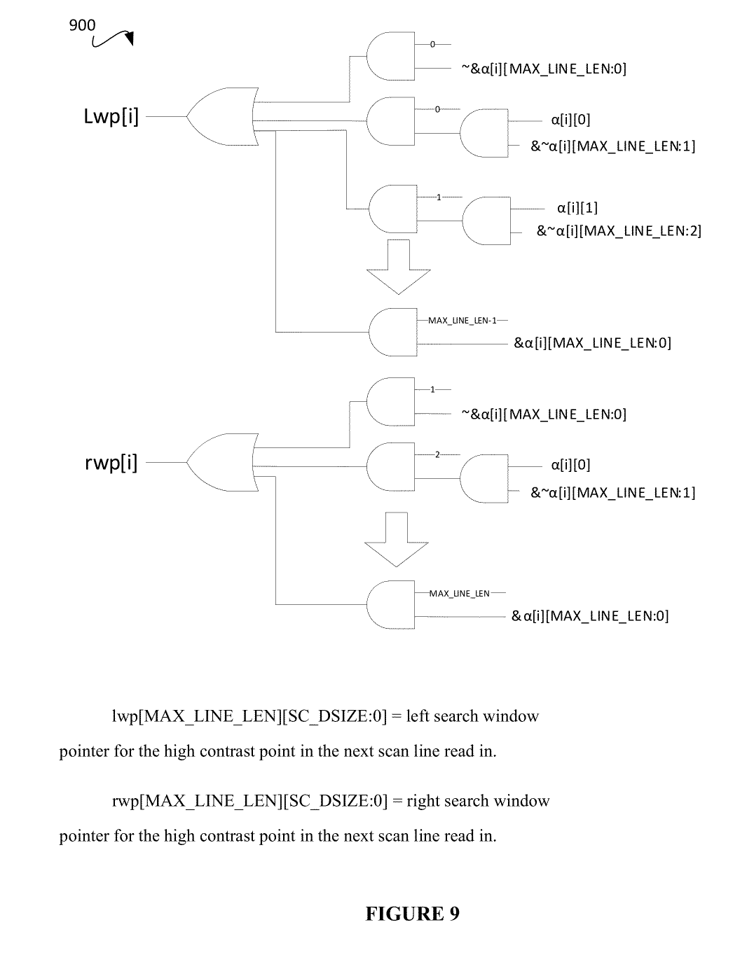

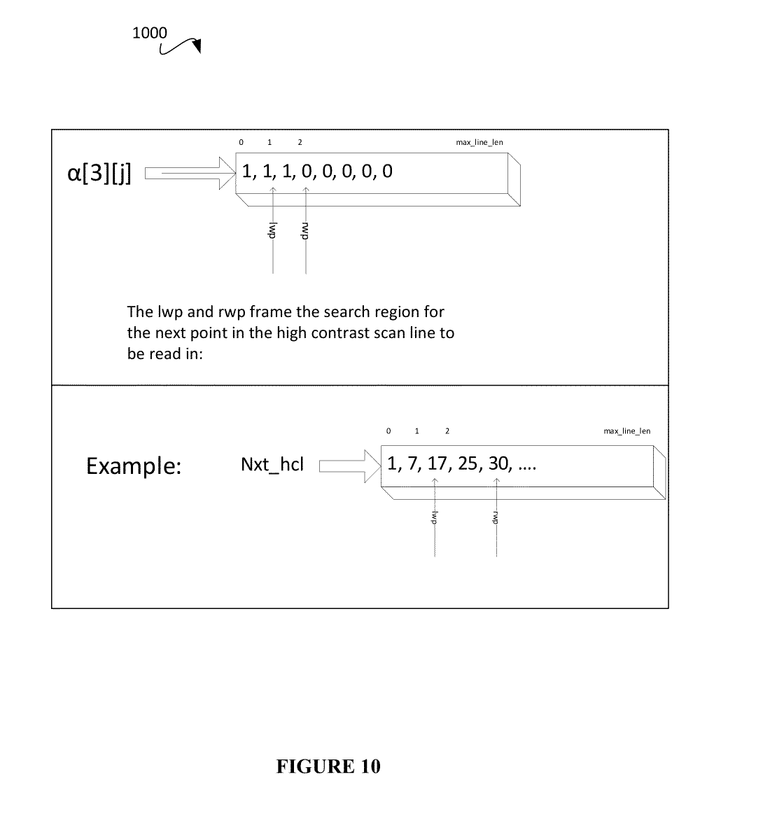

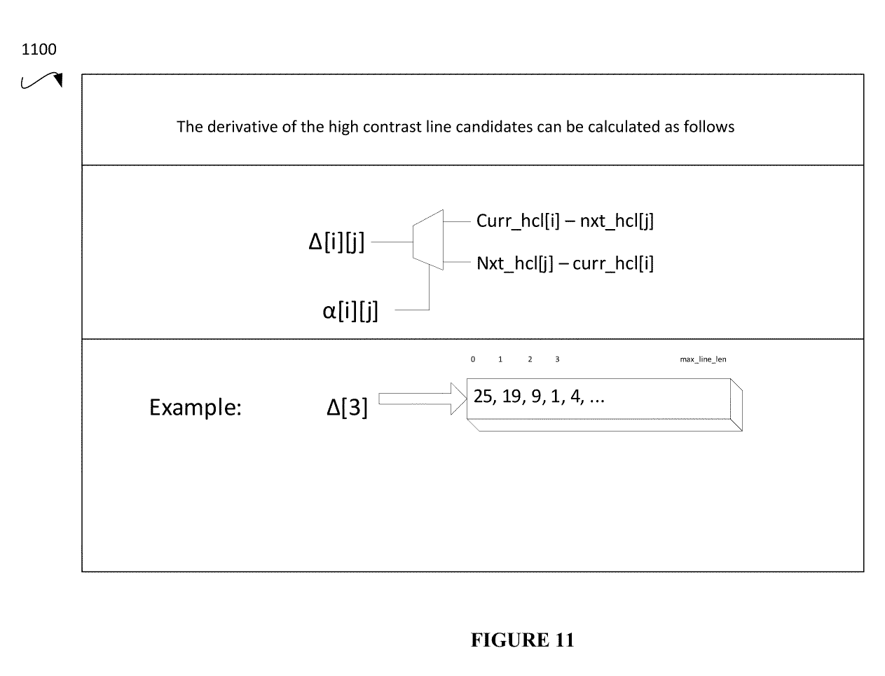

The α register file for each high contrast point may be used to generate pointers which bound the compare range of the next point in the high contrast line. The next high contrast point in the line traversing the y-axis can be selected from one plus and minus the delta transition (indicated by α[i]=!α[i]). In this regard, FIG. 9, provides a digital logic diagram 900 providing the logic to identify search windows for the high contrast points. Using the data from the example data provided in Table 2 above, the left and right window pointers for the search window in the next scan line are provided in the table 1000 depicted in FIG. 10. In this regard, the above logic can be adjusted to provide larger windows based on the pixel density and finger print resolution. Then, the derivative of the high contrast line candidates can be calculated as follows using the formula and logic provided in the table 1100 in FIG. 11:

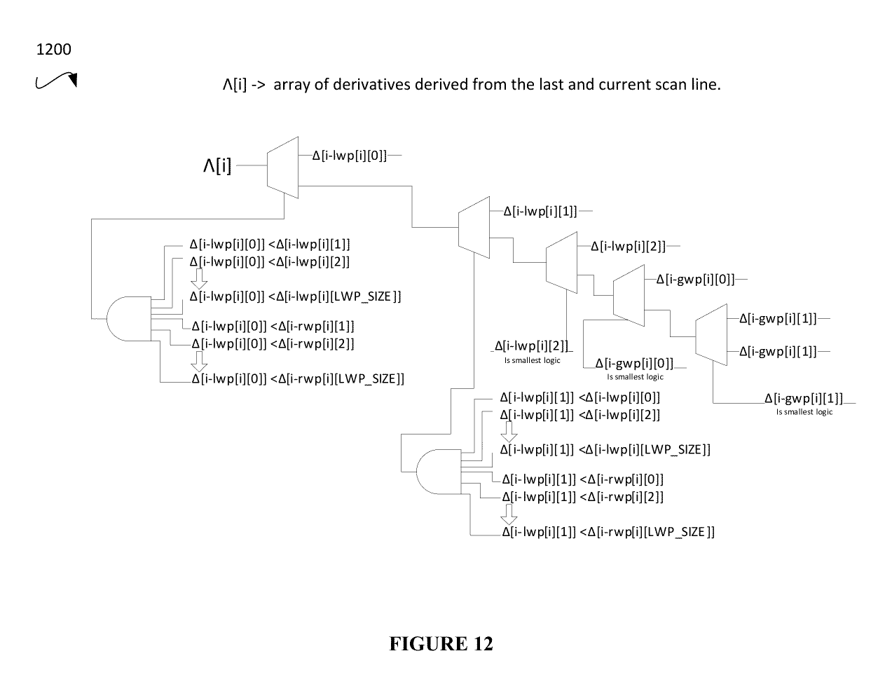

Once the derivative of each adjacent point in the incoming scan line that resides within the low contract pointer window is calculated, a register file containing the derivatives for the closest points on a per line basis can be constructed as visually depicted in the digital logic diagram 1200, depicted in FIG. 12. The following logic may use the slope of the line calculated in the last Λ function to find the next point from the incoming scan line which has the closest slope to the last. As a result, the line candidates are arranged into bins in the horizontal direction over a configurable distance.

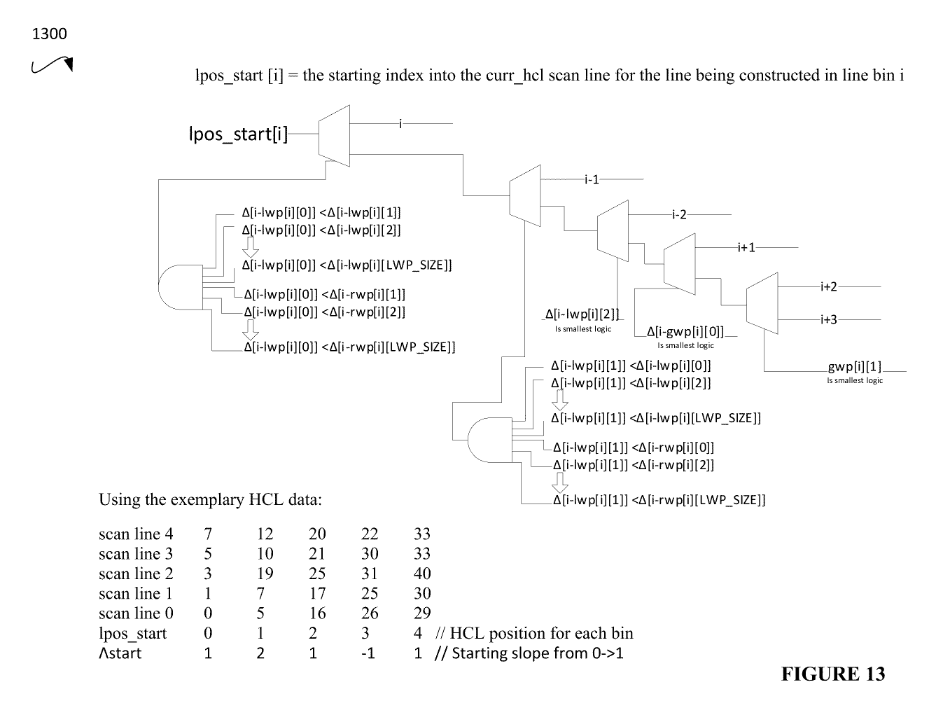

The logic provided for calculating the slope of the closest two adjacent points in two lines, identified here as Λ, may be used to generate the first best guess as to the slope of the HC lines found in the scan lines shown in Table 3 below. As used in herein “Λstart” will refer to the slope of the HC whereas “Λprev” will refer to the slope of the last two scan lines read in. The placement of each line under construction in the curr_hcl register scan line may be derived from the digital logic diagram 1300 shown in FIG. 13.

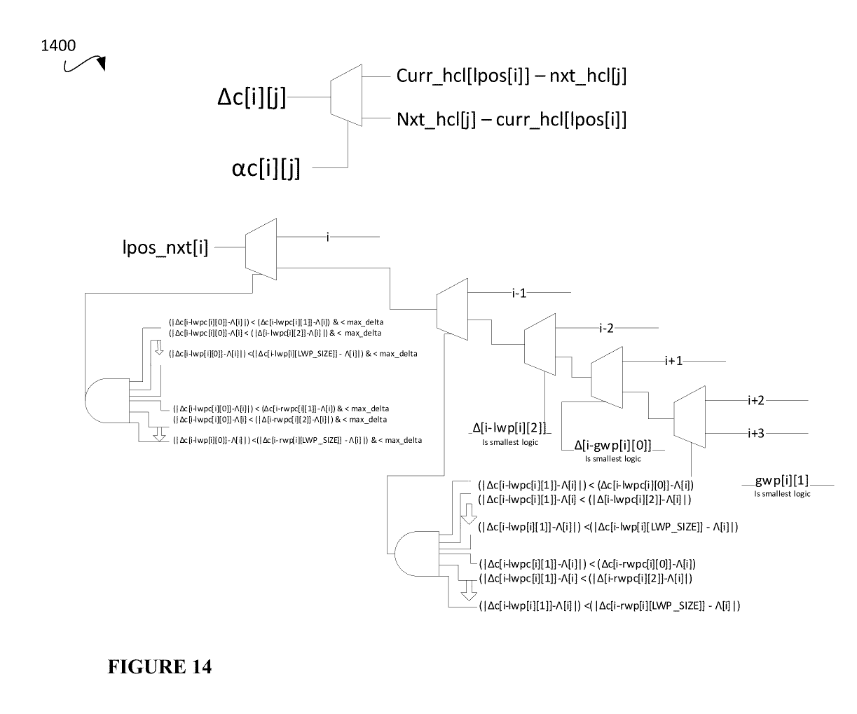

Now that the line candidates scan line position have been binned in lpos and the starting slope of the line have been identified, we can take each line candidate and find the next point in the next scan which has a slope closest to (within a configurable range) to the two points in the last two scan lines. Just as was done in the derivative logic for the last two scan lines, the a logic is utilized to find the high contrast window which is bounded by the low contrast lines for each high contrast point (lwp_c, gwp_c are the pointers). The Δ logic may be used to calculate the derivative for each line within the window (Δc). The next point in the line candidates can be selected in accordance with the digital logic diagram 1400 shown in FIG. 14.

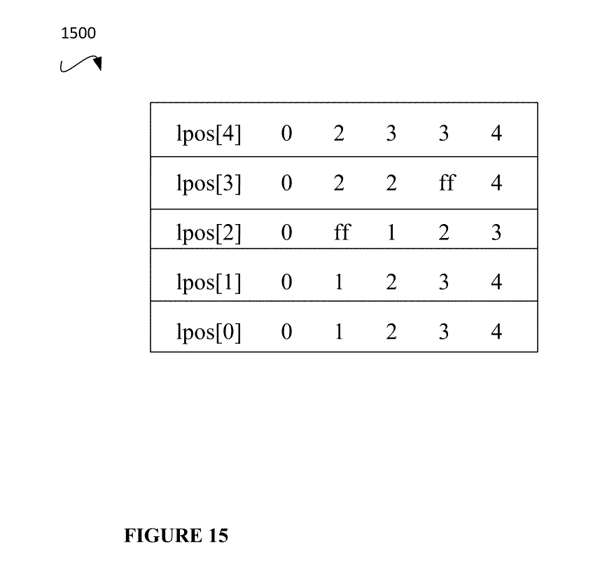

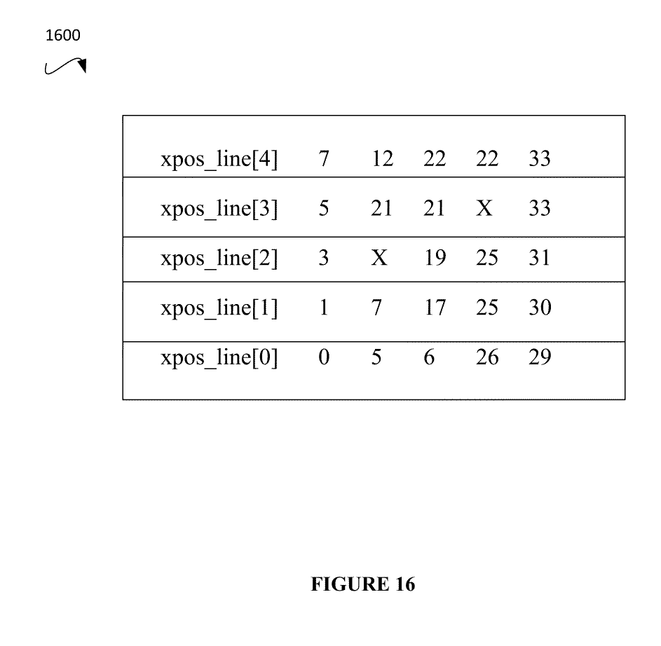

When the rate of change of the slope of the line exceeds max_delta (in the examples provided herein 2 is used), a value of 0xffh may be assigned to the lpos bin. Continuing the example from above and the associated diagrams, the lpos for the given scan lines would be as shown in the Table 1500 of FIG. 15: Now that the line positions are known, lpos is used as a pointer into both the curr_hcl and slope register files (e.g. xpos[line]=nxt_hcl[lpos[line]]). The slope and line positions from the example data given would be as shown in the Table 1600 of FIG. 16:

The lines with a configurable number of X's (in our example it is 0xFF) can be thrown out. From the example scan lines described herein, the line bins that contain an X can be discarded and one can see three lines constructed namely line bin 0, 2, and 4. These are the points that may be plugged into the polynomial point match logic to create a polynomial representation of the curvature for each high contrast point.

While the preferred embodiment of the present disclosure has been illustrated and described, it will be appreciated that various changes can be made therein without departing from the spirit and scope of the disclosed subject matter.

1. An integrated circuit configured to perform a method of filtering biometric data as a stream of fingerprint image data is received, the method comprising:
receiving an incoming stream of biometric data from a biometric sensor;
counting the number of bytes that exceed a programmable threshold over a given area as the data is received from the biometric sensor; and
using the count for the given area area to dynamically adjust the filter logic that is applied within the given area.
